(19) United States
(12) Patent Application Publication
(10) Pub. No.: US 2021/0252830 A1
(43) Pub. Date: Aug. 19, 2021

(54) ASSEMBLIES AND METHODS OF MAKING A SHIM

(71) Applicant: 3M INNOVATIVE PROPERTIES COMPANY, St. Paul, MN (US)

(72) Inventors: Jonathan D. Zook, Stillwater, MN (US); Chris A. Praggastis, Renton, WA (US)

(21) Appl. No.: 16/980,602

(22) PCT Filed: Jun. 7, 2019
(86) PCT No.: PCT/IB2019/054785

§ 371 Date: Sep. 14, 2020

Related U.S. Application Data
(60) Provisional application No. 62/685,870, filed on Jun. 15, 2018.

(51) Int. Cl. B32B 7/06; B32B 7/12; B32B 3/26; B33Y 80/00; B33Y 50/00; C09D 181/02

(52) U.S. Cl. CPC B32B 7/06; B32B 7/12; B32B 3/266; B33Y 10/00; B33Y 50/00; C09D 181/02; B33Y 80/00

(57) ABSTRACT

Various embodiments disclosed relate to a shim pattern. The shim pattern includes a release film. The shim pattern further includes a curable composition disposed on the release film. There are various advantages to using the shim pattern disclosed herein. For example, according to various embodiments, the shim pattern can be used to easily produce a model of a gap between two components of an aircraft (e.g., an airplane, helicopter, drone, or spacecraft) that can be used to form a shim to close the gap.

### BACKGROUND

Determining the necessity, size, and shape of shims used in aircraft manufacture often requires a labor-intensive, iterative process. Generally, parts are temporarily assembled and then visually inspected and measured for gaps between the aircraft components such as a skin and substructure. The components may then be dismantled and a trial shim fabricated. The components may then be reassembled with the shim temporarily secured in place, to check the fit. This is a second temporary assembly operation and such operations may need to be repeated until the shim fit is satisfactory. This process can be very time consuming and costly. Hence, there is a need for methods and associated equipment to simplify the shim manufacturing process to reduce the cost and time consuming iterative steps that impact production flow.

### SUMMARY OF THE DISCLOSURE

Various embodiments disclosed relate to a shim pattern. The shim pattern includes a release film. The shim pattern further includes a curable composition disposed on the release film.

Various embodiments disclosed relate to an assembly comprising a first substrate and a second substrate. The shim pattern is disposed between the first substrate and the second substrate.

Various embodiments disclosed relate to a method of making the shim pattern. The shim pattern includes a release film. The shim pattern further includes a curable composition disposed on the release film. The method includes contacting the curable composition with at least one of the first release film and the second release film.

Various embodiments disclosed relate to a method of using a shim pattern. The shim pattern includes a release film. The shim pattern further includes a curable composition disposed on the release film. The method includes contacting the shim pattern with at least one of a first substrate and a second substrate. The method further includes moving at least one of the first substrate and the second substrate relative to each other to compress the curable composition. The method further includes at least partially curing the curable composition. The method further includes removing the at least partially cured composition from contact with at least one of the first substrate and the second substrate.

Various embodiments disclosed relate to a method of making a shim. The method includes providing or receiving an at least partially cured shim pattern. The shim pattern includes a release film. The shim pattern further includes a curable composition disposed on the release film. The shim pattern is formed from a process including contacting the curable composition with at least one of the first release film and the second release film. The method of making the shim includes rendering a digital copy of the cured shim pattern; and producing a shim based on the digital copy of the cured shim pattern.

Various embodiments disclosed relate to an airplane including a shim formed from a method including providing or receiving an at least partially cured shim pattern. The shim pattern includes a release film. The shim pattern further includes a curable composition disposed on the release film. The shim pattern is formed from a process including contacting the curable composition with at least one of the first release film and the second release film. The method of making the shim includes rendering a digital copy of the cured shim pattern; and producing a shim based on the digital copy of the cured shim pattern.

There are various advantages to using the shim pattern disclosed herein. For example, according to various embodiments, the shim pattern can be used to easily produce a model of a gap between two components of an aircraft (e.g., an airplane, helicopter, drone, or spacecraft) that can be used to form a shim to close the gap. According to various embodiments using the shim pattern allows a gap between aircraft components to be assessed in a non-iterative process. According to various embodiments the non-iterative process leads to greater efficiency and a more accurate assessment of a gap than, for example, a corresponding technique accomplished according to the method and assembly available under the trade name VERIFILM, available from Cytec Industries Woodland Park, N.J.

### BRIEF DESCRIPTION OF THE FIGURES

The drawings illustrate generally, by way of example, but not by way of limitation, various embodiments discussed in the present document.

FIG. 1 is a schematic diagram showing a shim pattern, in accordance with various embodiments.

FIG. 2 is a schematic diagram showing another embodiment of a shim pattern, in accordance with various embodiments.

FIG. 3 is a schematic diagram showing another embodiment of a shim pattern, in accordance with various embodiments.

FIG. 4 is a schematic diagram showing a method of making a cured shim pattern, in accordance with various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “organic group” as used herein refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4- 2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus, aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

In an aircraft, proper assembly of parts can be important to ensuring the structural integrity of an aircraft. For example, mounting an aerodynamic surface (e.g., a wing) or skin to the internal substructure such as a spar or a stringer requires fitting the parts together at mating surfaces without leaving any substantial gaps between the mating surfaces greater than a predetermined allowance. Any gaps greater than the predetermined allowance can be filled with a shim to improve aerodynamic performance and structural integrity.

Shims used for may be generally categorized according to three categories. Those categories can include solid shims, laminated peelable shims, and liquid shims. Solid shims are, in some cases, made of the same material as the parts that they are placed between, Laminated peelable shims may be made of foil layers that can be removed one-by-one until a good fit is achieved. Liquid shim materials may be useful in filling irregular or tapered interfaces. Liquid shim materials, however, are typically used to fill gaps no bigger than 0.7 mm in width.

The present disclosure provides methods and apparatus for creating a shim pattern, which is a temporary model of a gap between aircraft components that provides digital dimension data that can be used to machine shims with the appropriate size and shape. As described herein the term “shim pattern” can refer to the pattern in a cured or uncured state. This disclosure further describes manufacture of the shim and installation of the shim into the gap in an aircraft structure.

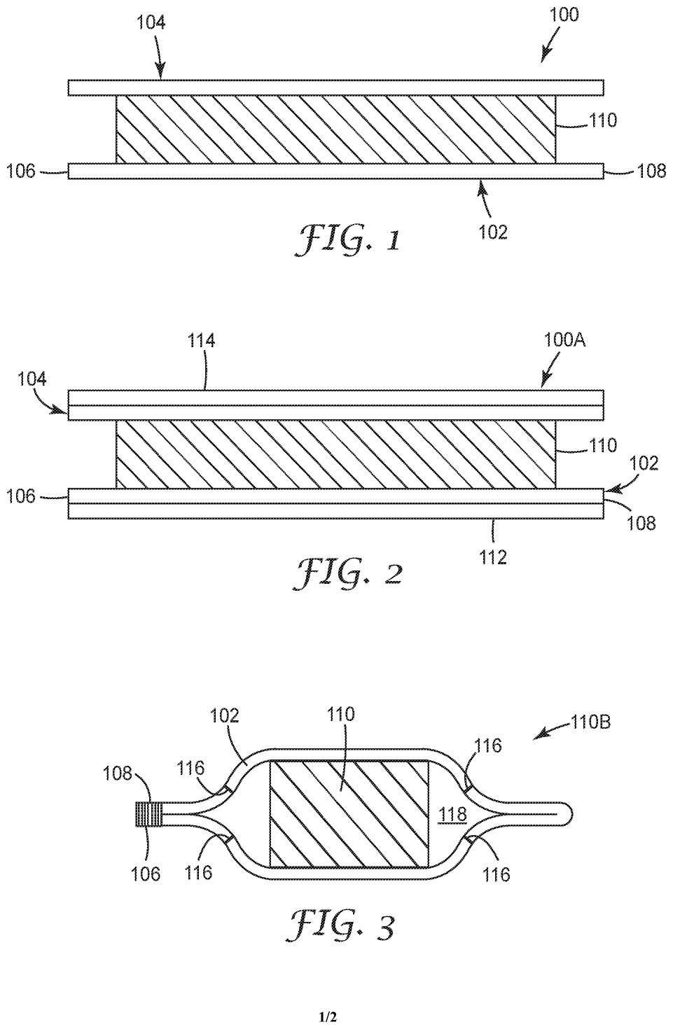

FIG. 1 is a schematic diagram showing shim pattern 100. Shim pattern 100 is used to form the temporary model of the gap between aircraft components. The model is ultimately used to form the shim that will be placed between the gaps. Shim pattern 100, as shown, includes first release film 102 and second release film 104. First release film 102 extends between opposite first end 106 and second end 108. Curable composition 110 is disposed on respective surfaces of first release film 102 and second release film 104.

First release film 102 and second release film 104 can be made from many suitable components of combinations of components. The components that first release film 102 and second release film 104 are made from should be relatively stiff and resistant to compression. The components of first release film 102 and second release film 104, should also be chosen from materials that will not adhere to the components of the aircraft that they contact. This makes it possible to remove shim pattern 100 relatively easily after use. In some embodiments it may be desirable to make first release film 102 and second release film 104 from materials that are fully, or at least partially, transparent to actinic radiation. A thickness of first release film 102 and second release film 104 can independently be in a range of from about 0.25 mil. to about 2 mil., about 0.90 mil. to about 1.1 mil., or less than, equal to, or greater than about, 0.25 mil., 0.30, 0.35, 0.40, 0.45, 0.50, 0.55, 0.60, 0.65, 0.70, 0.75, 0.80, 0.85, 0.90, 0.95, 1, 1.05, 1.10, 1.15, 1.20, 1.25, 1.30, 1.35, 1.40, 1.45, 1.50, 1.55, 1.60, 1.65, 1.70, 1.75, 1.80, 1.85, 1.90, 1.95, or about 2 mil. The combined thickness of first release film 102 and second release film 104 can set the minimum level to which shim pattern 100 (or any other shim pattern) can be compressed, if neither release film is compressible.

Examples of suitable materials for first release film 102 and second release film 104 include a polyolefin, a silicon, a polyester, or mixtures thereof. The polyolefin may be present in a range from 70 wt. % to 100 wt. %, 75 wt. % to 100 wt. %, 80 wt. % to 100 wt. %, 85 wt. % to 100 wt. %, 90 wt. % to 100 wt. %, 95 wt. % to 100 wt. %, or less than, equal to, or greater than about 70 wt. %, 75, 80, 85, 90, 95, or 100 wt %., based on the total weight of the of first release film 102 or second release film 104, independently. Suitable polyolefins may include at least one of polyethylene, polypropylene, polymethylpentene, polybutene-1, polyisobutylene, or a copolymer thereof. When the polyolefin is a copolymer, the copolymer may be arranged as a block copolymer, alternate copolymer, or random copolymer. The at least one polyolefin may be present as a distribution of polyolefins having different weight average molecular weights.

The polyolefins may have any suitable melt flow index value. Suitable melt flow index values may be in a range from 0.1 g/10 min. to 2000 g/10 min, 10 g/10 min. to 1000 g/10 min., 100 g/10 min. to 500 g/10 min., or 200 g/10 min. to 300 g/10 min. As understood melt flow index is a measure of the ease of flow of the melt of a thermoplastic polymer. It is defined as the mass of polymer, in grams, flowing in ten minutes through a capillary of a specific diameter and length by a pressure applied via prescribed alternative gravimetric weights for alternative prescribed temperatures.

In embodiments where the polyolefin is polyethylene, the polyethylene may have a density in a range from 0.80 g/cm³ to 0.86 g/cm³, in a range from 0.81 g/cm³ to 0.85 g/cm³, or 0.82 g/cm³ to 0.84 g/cm³. In additional embodiments, the polyethylene may have a density in a range from 0.90 g/cm³ to 0.92 g/cm³ or 0.90 g/cm³ to 0.91 g/cm³. In further embodiments, the polyethylene may have a density in a range from 0.92 g/cm³ to 0.96 g/cm³ or from 0.93 g/cm³ to 0.95 g/cm³.

In embodiments where the polyolefin is polypropylene, the polypropylene may be or include a biaxially oriented polypropylene (BOPP). Biaxially oriented polypropylenes may be formed by extruding a polypropylene film and stretching the film along two axes oriented at, for example, a ninety-degree angle with respect to each other. Film stretching along the two axes may be sequential or simultaneous. Biaxially oriented polypropylenes may increase strength and clarity of the polypropylene.

Curable composition 110 is a composition that can be thermally-curable, radiation-curable, chemically-curable, or a combination thereof. The term “thermally-curable” is meant to refer to compositions that can be cured at ambient or elevated temperatures. The term “radiation-curable” is meant to refer to compositions that can be cured upon exposure to electromagnetic radiation. The term “chemically-curable” is meant to refer to compositions that can be cured upon contact with a catalyst. In some embodiments, curable composition can have other properties that may be suitable for aerospace applications. For example, curable composition 110 may be substantially impervious to fuel.

In embodiments where curable composition 110 is radiation-curable, composition 110 can be cured upon exposure to actinic radiation. The term “actinic radiation” is meant to apply to electromagnetic radiation that can produce photochemical reactions. Actinic radiation can include electromagnetic radiation in the visible spectrum or in the ultra violet or infrared range.

In some embodiments the actinic radiation is blue light. The blue light can have a frequency in a range of from about 300 nm to about 500 nm, about 450 nm to about 495 nm, or less than equal to, or greater than about 300 nm, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or 500 nm. An intensity of the blue light can be in a range of from about 400 mW/cm² to about 1000 mW/cm², about 600 mW/cm² to about 900 mW/cm², or less than, equal to, or greater than about 400 mW/cm², 450, 500, 550, 600, 650, 700, 750, 800, 850, 900, 950, or about 1000 mW/cm². The blue light, or any other light, can be provided by any suitable source of electromagnetic radiation such as a light emitting diode (LED), mercury lamp, or halogen lamp.

Examples of suitable compositions for curable composition 110, include any composition that is capable of being cured upon exposure to blue light. In some embodiments, the curable compositions can include a polythioether, a polysulfide, or a fluorinated polymer. Curable composition 110 can also include an epoxy composition. In some embodiments, curable composition 110 can be a two-part composition, the first part of the two-part composition including at least a polythiol and the second part of the two-part composition including an unsaturated compound having at least two non-aromatic carbon-carbon double bonds, at least one carbon-carbon triple bond, or a combination thereof. Either of the first or second part can further include components chosen from an organoborane-amine complex, an organic peroxide, a photoinitiator system, and combinations thereof.

Useful polythiols are organic compounds having at least two (e.g., at least 2, at least 3, at least 4, or even at least 6) thiol groups.

Generally, in order to achieve chemical crosslinking between polymer chains in the curable composition 110, at least one of the polythiol(s) in component a) and/or at least one of the unsaturated compound(s) in component b) has an average equivalent functionality of at least 2, although this is not a requirement. For example, at least one of the polythiol(s) has three or more —SH groups and/or at least one of the unsaturated compound(s) has three or more terminal vinyl groups.

The stoichiometry of components a) and b) expressed as a ratio of —SH groups/vinyl groups preferably is in the range of 0.8 to 1.2, 0.9 to 1.1, or 0.95 to 1.05, although this is not a requirement.

A variety of polythiols having at least two thiol groups are useful according to the present disclosure. In some embodiments, the polythiol may be an alkylene, arylene, alkylarylene, arylalkylene, or alkylenearylalkylene having at least two mercaptan groups, wherein any of the alkylene, alkylarylene, arylalkylene, or alkylenearylalkylene are optionally interrupted by one or more oxa (i.e., —O—), thia (i.e., —S—), or imino groups (i.e., —NR³— wherein R³ is a hydrocarbyl group or H), and optionally substituted by alkoxy or hydroxyl.

Examples of useful dithiols include 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethyl sulfide, methyl-substituted dimercaptodiethyl sulfide, dimethyl-substituted dimercaptodiethyl sulfide, dimercaptodioxaoctane, 1,5-dimercapto-3-oxapentane, benzene-1,2-dithiol, benzene-1,3-dithiol, benzene-1,4-dithiol, and tolylene-2,4-dithiol. Examples of polythiols having more than two mercaptan groups include propane-1,2,3-trithiol; 1,2-bis[(2-mercaptoethyl)thio]-3-mercaptopropane; tetrakis(7-mercapto-2,5-dithiaheptyl)methane; and trithiocyanuric acid.

Also useful are polythiols formed from the esterification of polyols with thiol-containing carboxylic acids or their derivatives. Examples of polythiols formed from the esterification of polyols with thiol-containing carboxylic acids or their derivatives include those made from the esterification reaction between thioglycolic acid or 3-mercaptopropionic acid and several polyols to form the mercaptoacetates or mercaptopropionates, respectively.

Examples of polythiol compounds preferred because of relatively low odor level include, but are not limited to, esters of thioglycolic acid, α-mercaptopropionic acid, and β-mercaptopropionic acid with polyhydroxy compounds (polyols) such as diols (e.g., glycols), triols, tetraols, pentaols, and hexaols. Specific examples of such polythiols include, but are not limited to, ethylene glycol bis(thioglycolate), ethylene glycol bis(β-mercaptopropionate), trimethylolpropane tris(thioglycolate), trimethylolpropane tris(β-mercaptopropionate) and ethoxylated versions, pentaerythritol tetrakis(thioglycolate), pentaerythritol tetrakis(β-mercaptopropionate), and tris(hydroxyethyl)isocyanurate tris(β-mercaptopropionate). However, in those applications where concerns about possible hydrolysis of the ester exists, these polyols are typically less desirable.

Suitable polythiols also include those commercially available as THIOCURE PETMP (pentaerythritol tetra(3-mercaptopropionate)), TMPMP (trimethylolpropane tri(3-mercaptopropionate)), ETTMP (ethoxylated trimethylolpropane tri(3-mercaptopropionate) such as ETTMP 1300 and ETTMP 700), GDMP glycol di(3-mercaptopropionate), TMPMA (trimethylolpropane tri(mercaptoacetate)), TEMPIC (tris[2-(3-mercaptopropionyloxy)ethyl] isocyanurate), and PPGMP (propylene glycol 3-mercaptopropionate) from Bruno Bock Chemische Fabrik GmbH & Co. KG. A specific example of a polymeric polythiol is polypropylene-ether glycol bis(β-mercaptopropionate), which is prepared from polypropylene-ether glycol (e.g., PLURACOL P201, Wyandotte Chemical Corp.) and β-mercaptopropionic acid by esterification.

Suitable polythiols also include those prepared from esterification of polyols with thiol-containing carboxylic acids or their derivatives, those prepared from a ring-opening reaction of epoxides with H₂S (or its equivalent), those prepared from the addition of H₂S (or its equivalent) across carbon-carbon double bonds, polysulfides, polythioethers, and polydiorganosiloxanes. Specifically, these include the 3-mercaptopropionates (also referred to as β-mercaptopropionates) of ethylene glycol and trimethylolpropane (the former from Chemische Fabrik GmbH & Co. KG, the latter from Sigma-Aldrich); POLYMERCAPTAN 805C (mercaptanized castor oil); POLYMERCAPTAN 407 (mercaptohydroxy soybean oil) from Chevron Phillips Chemical Co. LLP, and CAPCURE, specifically CAPCURE 3-800 (a polyoxyalkylenetriol with mercapto end groups of the structure R³[O(C₃H₆O)ₙCH₂CH(OH)CH₂SH]₃ wherein R³ represents an aliphatic hydrocarbon group having 1-12 carbon atoms and n is an integer from 1 to 25), from Gabriel Performance Products, Ashtabula, Ohio, and GPM-800, which is equivalent to CAPCURE 3-800, also from Gabriel Performance Products.

Examples of oligomeric or polymeric polythioethers useful for practicing the present disclosure are described, for example, in U.S. Pat. No. 4,366,307 (Singh et al.), U.S. Pat. No. 4,609,762 (Morris et al.), U.S. Pat. No. 5,225,472 (Cameron et al.), U.S. Pat. No. 5,912,319 (Zook et al.), U.S. Pat. No. 5,959,071 (DeMoss et al.), U.S. Pat. No. 6,172,179 (Zook et al.), and U.S. Pat. No. 6,509,418 (Zook et al.), the contents of which are hereby incorporated by reference.

In some embodiments, the polythiol according to the present disclosure is oligomeric or polymeric. Examples of useful oligomeric or polymeric polythiols include polythioethers and polysulfides. Polythioethers include thioether linkages (i.e., —S—) in their backbone structures. Polysulfides include disulfide linkages (i.e., —S—S—) in their backbone structures.

Polythioethers can be prepared, for example, by reacting dithiols with dienes, diynes, divinyl ethers, diallyl ethers, ene-ynes, alkynes, or combinations of these under free-radical conditions. Useful dithiols include any of the dithiols listed above. Examples of suitable divinyl ethers include divinyl ether, ethylene glycol divinyl ether, butanediol divinyl ether, hexanediol divinyl ether, diethylene glycol divinyl ether, triethylene glycol divinyl ether, tetraethylene glycol divinyl ether, cyclohexanedimethanol divinyl ether, polytetrahydrofuryl divinyl ether, and combinations of any of these. Useful divinyl ethers of formula CH₂═CHO(R³O)ₘCH═CH₂, in which m is a number from 0 to 10, R³ is C₂ to C₆ branched alkylene. Such compounds can be prepared by reacting a polyhydroxy compound with acetylene. Examples of compounds of this type include compounds in which R³ is an alkyl-substituted methylene group such as —CH(CH₃)— (e.g., those obtained from BASF, Florham Park, N.J., under the trade designation “PLURIOL”, for which R³ is ethylene and m is 3.8) or an alkyl-substituted ethylene (e.g., —CH₂CH(CH₃)— such as those obtained from International Specialty Products of Wayne, N.J., under the trade designation “DPE” (e.g., DPE-2 and DPE-3). Examples of other suitable dienes, diynes, and diallyl ethers include 4-vinyl-1-cyclohexene, 1,5-cyclooctadiene, 1,6-heptadiyne, 1,7-octadiyne, and diallyl phthalate. Small amounts of trifunctional compounds (e.g., triallyl-1,3,5-triazine-2,4,6-trione, 2,4,6-triallyloxy-1,3,5-triazine) may also be useful in the preparation of oligomers.

Examples of oligomeric or polymeric polythioethers useful for practicing the present disclosure are described, for example, in U.S. Pat. No. 4,366,307 (Singh et al.), U.S. Pat. No. 4,609,762 (Morris et al.), U.S. Pat. No. 5,225,472 (Cameron et al.), U.S. Pat. No. 5,912,319 (Zook et al.), U.S. Pat. No. 5,959,071 (DeMoss et al.), U.S. Pat. No. 6,172,179 (Zook et al.), and U.S. Pat. No. 6,509,418 (Zook et al.), the contents of which are hereby incorporated by reference. In some embodiments, the polythioether is represented by formula HSR⁴[S(CH₂)₂O[R⁵O]ₘ(CH₂)₂SR⁴]ₙSH, wherein each R⁴ and R⁵ is independently a C₂₋₆ alkylene, wherein alkylene may be straight-chain or branched, C₆₋₈ cycloalkylene, C₆₋₁₀ alkylcycloalkylene, —[(CH₂)ₚX]_{q}(CH₂)ᵣ in which at least one —CH₂— is optionally substituted with a methyl group, X is one selected from the group consisting of O, S and —NR⁶—, where R⁶ denotes hydrogen or methyl, m is a number from 0 to 10, n is a number from 1 to 60, p is an integer from 2 to 6, q is an integer from 1 to 5, and r is an integer from 2 to 10. Polythioethers with more than two mercaptan groups may also be useful.

Polythioethers can also be prepared, for example, by reacting dithiols with diepoxides, which may be carried out by stirring at room temperature, optionally in the presence of a tertiary amine catalyst (e.g., 1,4-diazabicyclo[2.2.2]octane (DABCO)). Useful dithiols include any of those described above. Useful epoxides can be any of those having two epoxide groups. In some embodiments, the diepoxide is a bisphenol diglycidyl ether, wherein the bisphenol (i.e., —OC₆H₅CH₂C₆H₅O—) may be unsubstituted (e.g., bisphenol F), or either of the phenyl rings or the methylene group may be substituted by halogen (e.g., fluoro, chloro, bromo, iodo), methyl, trifluoromethyl, or hydroxymethyl. Polythioethers prepared from dithiols and diepoxides have pendent hydroxyl groups and can have structural repeating units represented by formula —SR⁴SCH₂CH(OH)CH₂OC₆H₅CH₂C₆H₅OCH₂CH(OH)CH₂SR⁴S—, wherein R⁴ is as defined above, and the bisphenol (i.e., —OC₆H₅CH₂C₆H₅O—) may be unsubstituted (e.g., bisphenol F), or either of the phenyl rings or the methylene group may be substituted by halogen (e.g., fluoro, chloro, bromo, iodo), methyl, trifluoromethyl, or hydroxymethyl. Mercaptan terminated polythioethers of this type can also be reacted with any of the dienes, diynes, divinyl ethers, diallyl ethers, and ene-ynes listed above under free-radical polymerization conditions.

Other useful polythiols can be formed from the addition of hydrogen sulfide (H₂S) (or its equivalent) across carbon-carbon double bonds. For example, dipentene and triglycerides which have been reacted with H₂S (or its equivalent). Specific examples include dipentene dimercaptan and those polythiols available as POLYMERCAPTAN 358 (mercaptanized soybean oil) and POLYMERCAPTAN 805C (mercaptanized castor oil) from Chevron Phillips Chemical Co. LLP. At least for some applications, the preferred polythiols are POLYMERCAPTAN 358 and 805C since they are produced from largely renewable materials, i.e., the triglycerides, soybean oil and castor oil, and have relatively low odor in comparison to many thiols. Useful triglycerides have at least 2 sites of unsaturation, i.e., carbon-carbon double bonds, per molecule on average, and sufficient sites are converted to result in at least 2 thiols per molecule on average. In the case of soybean oil, this requires a conversion of approximately 42 percent or greater of the carbon-carbon double bonds, and in the case of castor oil this requires a conversion of approximately 66 percent or greater of the carbon-carbon double bonds. Typically, higher conversion is preferred, and POLYMERCAPTAN 358 and 805C can be obtained with conversions greater than approximately 60 percent and 95 percent, respectively. Useful polythiols of this type also include those derived from the reaction of H₂S (or its equivalent) with the glycidyl ethers of bisphenol A epoxy resins, bisphenol F epoxy resins, and novolak epoxy resins. A preferred polythiol of this type is QX11, derived from bisphenol A epoxy resin, from Japan Epoxy Resins (JER) as EPOMATE. Other polythiols suitable include those available as EPOMATE QX10 and EPOMATE QX20 from JER.

Still other useful polythiols are polysulfides that contain thiol groups such as those available as THIOKOL LP-2, LP-3, LP-12, LP-31, LP-32, LP-33, LP-977, and LP-980 from Toray Fine Chemicals Co., Ltd., and polythioether oligomers and polymers such as those described in PCT Publ. No. WO 2016/130673 A1 (DeMoss et al.), the contents of which are hereby incorporated by reference.

Combinations of polythiols may be used. Preferred combinations include miscible mixtures, although this is not a requirement.

The unsaturated compound can include at least one unsaturated compound having at least two non-aromatic carbon-carbon double bonds, at least one carbon-carbon triple bond, or a combination thereof. In some embodiments, the non-aromatic carbon-carbon double bonds correspond to vinyl groups.

In some embodiments, the unsaturated compounds are represented by the general formula:

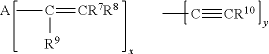

wherein:
A represents an x+y valent organic group (e.g., preferably consisting of C and H, but optionally substituted by hydroxy, alkoxy, aryloxy, carbonyl, acyloxy, carboalkoxy, and sulfur-based derivatives thereof, optionally substituted by one or more of S, N, and P), having from 1 to 8, 12, 18, 22, or even 30 carbon atoms; each R⁷, R⁸, R⁹, and R¹⁰ independently represents H or an organic group having from 1 to 8 carbon atoms (preferably 1 to 4, and more preferably 1 or 2 carbon atoms)), or R⁷ and R⁸ may together form a 5- or 6-membered ring; and x and y independently represent integers in the range of 0 to 6, wherein 1≤x+y≤6 with the proviso that if y=0 then x≥2.

Examples of suitable unsaturated compounds include, for example: unsaturated hydrocarbon compounds having from 5 to 30 carbon atoms (preferably 5 to 18 carbon atoms) such as, for example, include 1,4-pentadiene, 1,5-hexadiene, 1,6-heptadiene, 1,7-octadiene, 1,8-nonadiene, 1,9-decadiene, 1,10-undecadiene, 1,11-dodecadiene, 1,13-tetradecadiene, 1,15-hexadecadiene, 1,17-octadecadiene, 1,19-icosadiene, 1,21-docosadiene, divinylbenzene, dicyclopentadiene, limonene, diallylbenzene, triallylbenzene; polyvinyl ethers having from 4 to 30 carbon atoms (preferably 4 to 18) carbon atoms such as, for example, divinyl ether, ethylene glycol divinyl ether, 1,4-butanediol divinyl ether, 1,6-hexanediol divinyl ether, diethylene glycol divinyl ether, triethylene glycol divinyl ether, tetraethylene glycol divinyl ether, cyclohexanedimethanol divinyl ether, trimethylolpropane trivinyl ether, and pentaerythritol tetravinyl ether, bisphenol A divinyl ether, biphenol F divinyl ether, bisphenol A diallyl ether, bisphenol F diallyl ether; diynes having from 5 to 30 carbon atoms (preferably 5 to 15 carbon atoms) such as, for example, 1,6-heptadiyne; isocyanurates having from 9 to 30 carbon atoms (preferably 9 to 15 carbon atoms) such as, for example, diallyl isocyanurate and triallyl isocyanurate; cyanurates having from 9 to 30 carbon atoms (preferably 9 to 15 carbon atoms) such as, for example, diallyl cyanurate, and triallyl cyanurate; and certain ethenyl and/or ethynyl-substituted polymers such as, for example, polytetrahydrofuryl divinyl ether, polyethylene oxide divinyl ether, polyethylene oxide diallyl ether, polypropylene oxide divinyl ether, polypropylene oxide diallyl ether, and mixtures thereof. Ethenyl and/or ethynyl-substituted polymers may have two, three, four, or more ethenyl (e.g., vinyl) and/or ethynyl (e.g., acetylenyl) pendant group and/or end groups. Compounds having both ethenyl and ethynyl groups may also be used. Combinations of the foregoing may be used.

In some embodiments, the carbon-carbon double and triple bonds are terminal groups in a linear aliphatic compound. In some embodiments, one or more of the carbon-carbon double and triple bonds are contained within carbocyclic ring structures having from 4-10 carbon atoms. In some cases, these ring structure may contain multiple fused or bonded rings or heteroatoms such as O, S or N. When using polythiols having two thiol groups, a mixture of unsaturated compounds may be useful in which at least one unsaturated compound has two carbon-carbon double or triple bonds, and at least one unsaturated compound has at least three carbon-carbon double or triple bonds.

The organoborane-amine complex can be a latent form of an organoborane which is liberated upon decomplexing the base with a compound that reacts with the base, such as an acid or its equivalent. The free organoborane is an initiator capable of initiating free-radical polymerization of curable composition 110, for example.

The organoborane portion of the organoborane-amine complex is shown in Formula I (below):

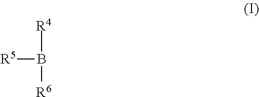

wherein R⁴, R⁵, and R⁶ are organic groups (typically having 30 atoms or less, or 20 atoms or less, or 10 atoms or less). In certain embodiments of Formula I, R⁴ represents an alkyl group having from 1 to 10 carbon atoms, or from 1 to 6 carbon atoms, or from 1 to 5 carbon atoms, or from 1 to 4 carbon atoms, or from 2 to 4 carbon atoms, or from 3 to 4 carbon atoms.

In certain embodiments of Formula I, R⁵ and R⁶ independently represent (e.g., they may be the same or different): alkyl groups having 1 to 10 carbon atoms (or from 1 to 6 carbon atoms, or from 1 to 5 carbon atoms, or from 1 to 4 carbon atoms, or from 2 to 4 carbon atoms, or from 3 to 4 carbon atoms); cycloalkyl groups having 3 to 10 carbon atoms; aryl groups having from 6 to 12 carbon atoms (e.g., phenyl); or aryl groups having from 6 to 12 carbon atoms (e.g., phenyl) substituted with alkyl groups having 1 to 10 carbon atoms (or from 1 to 6 carbon atoms, or from 1 to 5 carbon atoms, or from 1 to 4 carbon atoms, or from 2 to 4 carbon atoms, or from 3 to 4 carbon atoms), or cycloalkyl groups having 3 to 10 carbon atoms. Any two of R⁴, R⁵, and R⁶ groups may optionally be part of a ring (e.g., two groups can combine to form a ring).

The organoborane initiator is complexed with a basic complexing agent (i.e., a base that complexes with the organoborane) to form a stable organoborane-amine complex. The organoborane-amine complex may be represented by Formula II (below):

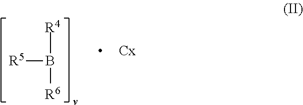

wherein R⁴, R⁵, and R⁶ are as previously defined, and Cx represents a complexing agent selected from a compound having one or more amine groups and optionally one or more alkoxyl groups; and v is a positive number. The value of v is selected so as to render the organoborane-amine complex stable under ambient conditions. For example, when the organoborane-amine complex is stored in a capped vessel at about 20 to 22° C. and under otherwise ambient conditions (i.e., the vessel is capped in an ambient air environment and not under vacuum or an inert atmosphere), the complex remains useful as an initiator for at least two weeks. Preferably, the complexes may be readily stored under these conditions for many months, and up to a year or more. In certain embodiments, the value of v is typically at least 0.1, or at least 0.3, or at least 0.5, or at least 0.8, or at least 0.9 and, up to 2, or up to 1.5, or up to 1.2. In some embodiments, v is in a range of 0.1 to 2, or in a range of 0.5 to 1.5, or in a range of 0.8 to 1.2, or in a range of 0.9 to 1.1, or 1.

In Formulas I and II, an alkyl group may be straight chain or branched. In certain embodiments, a ring formed by two groups of R⁴, R⁵, and R⁶ may be bridged by the boron atom in Formula I or Formula II.

In some embodiments, the organoborane-amine complex does not include a thiol group.

Suitable organoboranes of the organoborane-amine complexes are trimethylborane, triethylborane, tri-n-propylborane, triisopropylborane, tri-n-butylborane, triisobutylborane, and tri-sec-butylborane.

Useful basic complexing agents (Cx) include, for example, amines, aminoalcohols, aminoethers and compounds that contain a combination of such functionality (e.g., an amino group and an alkoxy group). Sufficient complexing agent is provided to ensure stability of the organoborane-amine complex under ambient conditions. Insufficient complexing agent could leave free organoborane, a material that tends to be pyrophoric. In practice, to ensure stability of the complex at ambient conditions, the compound that serves as the complexing agent is often in excess, i.e., some of the compound is free or not complexed in the composition. The amount of excess basic complexing agent is chosen to ensure stability of the complex under ambient conditions while still achieving desired performance such as cure rate of the polymerizable composition and mechanical properties of the cured composition. For example, there may be up to 100 percent molar excess, or up to 50 percent molar excess, or up to 30 percent molar excess of the basic complexing agent relative to the organoborane. Often, there is 10 to 30% molar excess of the basic complexing agent relative to the organoborane.

Useful basic complexing agents include, for example, amines and aminoethers. The amine compounds may have primary and/or secondary amino group(s), for example.

Amine complexing agents (Cx) may be provided by a wide variety of materials having one or more primary (typically preferred) or secondary amine groups, including blends of different amines. Amine complexing agents may be a compound with a single amine group or may be a polyamine (i.e., a material having multiple amine groups such as two or more primary, secondary, or tertiary amine groups). Suitable polyamines preferably have at least one amine group that is a primary and/or secondary amine group.

The organoborane-amine complex may be readily prepared using known techniques, as described, for example, in U.S. Pat. No. 5,616,796 (Pocius et al.), U.S. Pat. No. 5,621,143 (Pocius), U.S. Pat. No. 6,252,023 (Moren), U.S. Pat. No. 6,410,667 (Moren), and U.S. Pat. No. 6,486,090 (Moren), the contents of which are hereby incorporated by reference.

Suitable organoborane-amine complexes are available from suppliers such as BASF and AkzoNobel. TEB-DAP (triethylborane-1,3-diaminopropane (or 1,3-propanediamine) complex), TnBB-MOPA (tri-n-butylborane-3-methoxypropylamine complex), TEB-DETA (triethylborane-diethylenetriamine complex), TnBB-DAP (tri-n-butylborane-1,3-diaminopropane complex), and TsBB-DAP (tri-sec-butylborane-1,3-diaminopropane complex) are all available from BASF (Ludwigshafen, Germany). TEB-HMDA (triethylborane-hexamethylenediamine (also 1,6-hexanediamine or 1,6-diaminohexane) complex) is available from AkzoNobel, Amsterdam, The Netherlands.

The organoborane-amine complex is generally employed in an effective amount, which is an amount large enough to permit reaction (i.e., curing by polymerizing and/or crosslinking) to readily occur to obtain a polymer of sufficiently high molecular weight for the desired end use. If the amount of organoborane produced is too low, then the reaction may be incomplete. On the other hand, if the amount is too high, then the reaction may proceed too rapidly to allow for effective mixing and use of the resulting composition.

Within these parameters, an effective amount of the organoborane-amine complex is an amount that preferably provides at least 0.003 percent by weight of boron, or at least 0.008 percent by weight of boron, or at least 0.01 percent by weight of boron. An effective amount of the organoborane-amine complex is an amount that preferably provides up to 1.5 percent by weight of boron, or up to 0.5 percent by weight of boron, or up to 0.3 percent by weight of boron. The percent by weight of boron in a composition is based on the total weight of the polymerizable material.

Alternatively stated, an effective amount of the organoborane-amine complex is at least 0.1 percent by weight, or at least 0.5 percent by weight. An effective amount of the organoborane-amine complex is up to 10 percent by weight, or up to 5 percent by weight, or up to 3 percent by weight. The percent by weight of boron in a composition is based on the total weight of the polymerizable material.

A decomplexing agent may be included to activate the organoborane-amine complex, however, it is presently discovered that it is generally not needed; for example, curable composition 110 may contain less than 1, less than 0.1, or less than 0.01 weight percent of the decomplexing agent, or even be free of the decomplexing agent. As used herein, the term “decomplexing agent” refers to a compound capable of liberating the organoborane from its complexing agent, thereby enabling initiation of the reaction (curing by polymerizing and/or crosslinking) of the polymerizable material of the composition. Decomplexing agents may also be referred to as “activators” or “liberators” and these terms may be used synonymously herein.

Compounds that react quickly with the base or the organoborane-amine complex under mild temperatures are particularly effective decomplexing agents. These may include mineral acids, Lewis acids, carboxylic acids, acid anhydrides, acid chlorides, sulfonyl chlorides, phosphonic acids, isocyanates, aldehydes, 1,3-dicarbonyl compounds, acrylates, and epoxies.

In certain embodiments, the decomplexing agent may be attached to solid particles such as silica, titanium dioxide, alumina, calcium carbonate, and carbon black.

Suitable decomplexing agents may include amine-reactive compounds. The amine-reactive compound liberates organoborane by reacting with the amine, thereby removing the organoborane from chemical attachment with the amine. A wide variety of materials may be used to provide the amine-reactive compound including combinations of different materials. Desirable amine-reactive compounds are those materials that can readily form reaction products with amines at or below room temperature so as to provide a composition such as an adhesive that can be easily used and cured under ambient conditions.

General classes of useful amine-reactive compounds include mineral acids (e.g., hydrochloric acid, sulfuric acid, phosphoric acid, and silicic acid), Lewis acids (e.g., SnCl₄ or TiCl₄), carboxylic acids, acid anhydrides (i.e., organic compounds that have two acyl groups bound to the same oxygen atom), acid chlorides, sulfonyl chlorides, phosphonic acids, phosphinic acids, isocyanates, aldehydes, 1,3-dicarbonyl compounds, acrylates, and epoxies. Compounds that react quickly with amines at mild temperatures, such as acids, acid anhydrides, acid chlorides, sulfonyl chlorides, and isocyanates, are particularly effective decomplexing agents.

In addition, strong acids, such as many mineral acids, may degrade the components of the polymerizable composition before or after reaction, and also can degrade or corrode substrates that the composition may contact. Owing to these facts, carboxylic acids, acid anhydrides, aldehydes, isocyanates, phosphonic acids, and 1,3-dicarbonyl compounds, such as barbituric acid, dimedone, and their derivatives, are typically more versatile and preferred decomplexing agents.

Other useful amine-reactive compounds having at least one anhydride group are copolymers of maleic anhydride, such as the copolymers of maleic anhydride and styrene, the copolymers of maleic anhydride and ethylene or a-olefins, and the copolymers of maleic anhydride and (meth)acrylates. Also, polymeric materials in which maleic anhydride has been grafted onto the polymer to form, for example, succinic anhydride-functional polymers are suitable. Polydiorganosiloxanes that contain anhydrides may also be useful, such as Gelest, Inc. succinic anhydride-terminated polydimethylsiloxane, DMS-Z21.

Examples of aldehydes useful as the amine-reactive compounds that serve as decomplexing agents include: benzaldehyde; o-, m- and p-nitrobenzaldehyde; 2,4-dichlorobenzaldehyde; p-tolylaldehyde; and 3-methoxy-4-hydroxybenzaldehyde. Blocked aldehydes, such as acetals and dialdehydes, may also be used.

Other suitable decomplexing agents may include 1,3-dicarbonyl compounds (e.g., β-ketones), for example, as described in U.S. Pat. No. 6,849,569 (Moren). Exemplary 1,3-dicarbonyl compound decomplexing agents include methyl acetoacetate, ethyl acetoacetate, t-butyl acetoacetate, 2-methacryloyloxyethyl acetoacetate, diethylene glycol bis(acetoacetate), polycaprolactone tris(acetoacetate), polypropylene glycol bis(acetoacetate), acetoacetanilide, ethylene bis(acetoacetamide), polypropylene glycol bis(acetoacetamide), acetoacetamide, and acetoacetonitrile. Preferred 1,3-dicarbonyl compounds include dimedone, barbituric acid and their derivatives (e.g., 1,3-dimethylbarbituric acid, 1-phenyl-5-benzylbarbituric acid, and 1-ethyl-5-cyclohexyl-barbituric acid).

If present, the decomplexing agent is typically used in an effective amount (i.e., an amount effective to promote reaction (i.e., curing by polymerizing and/or crosslinking) by liberating the initiator from its complexing agent, but without materially adversely affecting desired properties of the ultimate composition). As recognizable to one of ordinary skill in the art, too much of the decomplexing agent may cause reaction to proceed too quickly. However, if too little decomplexing agent is used, the rate of reaction may be too slow and the resulting polymers may not be of adequate molecular weight for certain applications. A reduced amount of decomplexing agent may be helpful in slowing the rate of reaction if it is otherwise too fast. Thus, within these parameters, the decomplexing agent is typically provided in an amount such that the molar ratio of amine-reactive groups in the decomplexing agent(s) to amino groups in the complexing agent(s) is in the range of 0.5:1.0 to 10.0:1.0, preferably in the range of 0.5:1.0 to 4.0:1.0, and more preferably 1.0:1.0, although this is not a requirement.

Examples of useful organic peroxides include hydroperoxides (e.g., cumene, tert-butyl or tert-amyl hydroperoxide), dialkyl peroxides (e.g., di-tert-butylperoxide, dicumylperoxide, or cyclohexyl peroxide), peroxyesters (e.g., tert-butyl perbenzoate, tert-butyl peroxy-2-ethylhexanoate, tert-butyl peroxy-3,5,5-trimethylhexanoate, tert-butyl monoperoxymaleate, or di-tert-butyl peroxyphthalate), peroxycarbonates (e.g., tert-butylperoxy 2-ethylhexylcarbonate, tert-butylperoxy isopropyl carbonate, or di(4-tert-butylcyclohexyl) peroxydicarbonate), ketone peroxides (e.g., methyl ethyl ketone peroxide, 1,1-di(tert-butylperoxy)cyclohexane, 1,1-di(tert-butylperoxy)-3,3,5-trimethylcyclohexane, and cyclohexanone peroxide), and diacylperoxides (e.g., benzoyl peroxide or lauryl peroxide). The organic peroxide may be selected, for example, based on the temperature desired for use of the organic peroxide and compatibility with the monomers. Combinations of two or more organic peroxides may also be useful.

Organic peroxides, in some embodiments organic hydroperoxides, can be added in any amount suitable to initiate curing. In some embodiments, the organic peroxide is present in an amount in a range from 0.05 weight percent to about 10 weight percent (in some embodiments, 0.1 weight percent to 5 weight percent, or 0.5 weight percent to 5 weight percent). The organic peroxide and its amount may be selected to provide the composition with a desirable second time period (that is, the length of time a portion of curable composition 110 adjacent the surface of the aircraft remains liquid) after it is mixed or thawed. In some embodiments, the composition has an open time of at least 10 minutes, at least 30 minutes, at least one hour, or at least two hours.

The photoinitiator system may e capable of generating free radicals upon exposure to actinic radiation (preferably electromagnetic radiation). Typically, the actinic radiation will be electromagnetic radiation including wavelengths in the range of 250 to 500 nm, although other wavelengths may be used. In preferred embodiments, the actinic radiation is visible, and preferably contains light in the 400 to 470 nanometer wavelength range (more preferably 440-460 nanometers). The photoinitiator system may include Type-I and/or Type-II photoinitiators, sensitizing dyes, amine synergists, and optionally electron donors (e.g., as in the case of 3-component electron-transfer photoinitiators), for example.

Examples of suitable free-radical photoinitiators include 2-benzyl-2-(dimethylamino)-4′-morpholinobutyrophenone; 1-hydroxycyclohexyl-phenyl ketone; 2-methyl-1-[4-(methylthio)phenyl]-2-morpholinopropan-1-one; 4-methylbenzophenone; 4-phenyl benzophenone; 2-hydroxy-2-methyl-1-phenylpropanone; 1-[4-(2-hydroxyethoxyl)-phenyl]-2-hydroxy-2-methylpropanone; 2,2-dimethoxy-2-phenylacetophenone; 4-(4-methylphenylthio)benzophenone; benzophenone; 2,4-diethylthioxanthone; 4,4′-bis(diethylamino)benzophenone; 2-isopropylthioxanthone; and combinations thereof. Many of these and others are widely available from commercial sources.

The photoinitiator system comprises a free-radical photoinitiator that is sensitive to wavelengths in the visible region of the electromagnetic spectrum. Examples of such photoinitiators include acylphosphine oxide derivatives, acylphosphinate derivatives, and acylphosphine derivatives (e.g., phenylbis(2,4,6-trimethylbenzoyl)phosphine oxide (available as OMNIRAD 819 from IGM Resins, St. Charles, Ill.), phenylbis(2,4,6-trimethylbenzoyl)phosphine (e.g., as available as OMNIRAD 2100 from IGM Resins), bis(2,4,6-trimethylbenzoyl)phenylphosphine oxide, 2,4,6-trimethylbenzoyldiphenylphosphine oxide (e.g., as available as OMNIRAD 8953X from IGM Resins), isopropoxyphenyl-2,4,6-trimethylbenzoylphosphine oxide, dimethyl pivaloylphosphonate), ethyl (2,4,6-trimethylbenzoyl) phenyl phosphinate (e.g., as available as OMNIRAD TPO-L from IGM Resins); and, bis(cyclopentadienyl) bis[2,6-difluoro-3-(1-pyrryl)phenyl] titanium (e.g., as available as OMNIRAD 784 from IGM Resins).

While these photoinitiators may have low molar extinction coefficients at 450 nm, they nonetheless are typically sufficiently absorptive to provide sufficient curing using light emitting diode (LED) light sources at the indicated amounts.

Optionally, curable composition 110 may include one or more basic compounds such as, for example, amines such as 1,4-diazobicyclo[2.2.2]octane (DABCO), 1,2-dimethylimidazole, 3-quinuclidinol, and/or excess amine supplied with the organoborane-amine complex, and/or inorganic bases (e.g., magnesium hydroxide, sodium hydroxide, calcium hydroxide, calcium oxide, and sodium carbonate). If included, typical amounts are 0.1 to 8 weight percent, preferably 0.2 to 2 percent, although this is not a requirement. Further examples of suitable curable compositions can be found in published PCT applications WO2013/151893 (Ye), WO2014/164103 (Ye), WO2014/164244 (Ye), WO2014/172302 (Zook), WO2014/172305 (Zook), WO2016/106352 (Ye), WO2016/106364 (Swan), WO2016/130673 (Demoss), WO2016/176537 (Zook), WO2016/176548 (Ye), and WO2017/015188 (Blackwell) as well as U.S. Pat. No. 9,650,150 (Zook) as well as U.S. Patent Application 62/66,709 (Moser), the contents of which are hereby incorporated by reference.

Curable composition 110, can include further components such as a plurality of microspheres. The microspheres can be glass and can contain a compound or be empty. For example, the microspheres can include a catalyst, the microspheres can be adapted to break upon the application of a suitable amount of pressure to release the catalyst and begin curing. Empty microspheres can be helpful to ensure that curable composition 110 is not compressed below a certain predetermined value. This is because the microspheres act as a solid support that will not compress, thus setting a maximum compression level for curable composition 110. The microspheres can be made of glass. Glass microspheres can also be useful to help transfer actinic radiation such as blue light through curable composition 110. This can help to facilitate curing at locations in curable composition that are blocked by a non-transparent substance (e.g., an aircraft component as described further herein) or to help facilitate curing at locations that are too deep in curable composition 110 for the actinic radiation to penetrate. In addition to or instead of microspheres. Other materials such as hollow filaments or a woven hollow filament fiber fabric can be included in curable composition 110 to help transfer actinic radiation through curable composition 110. Any of the glass microspheres of filaments can extend from an external edge or surface of curable composition 110 to any desired depth of curable composition 110.

Microspheres can also be used to modify the viscosity of curable composition 110. Any other suitable viscosity modifier can be used as well. A viscosity of the curable composition can be any suitable value. For example, the viscosity can be at a value where curable composition 110 can flow and be deformed in an uncured state and substantially retain its form when at least partially cured. As an example, at ambient conditions (e.g., a temperature of about 25° C.) the viscosity of curable composition 110 is in a range of from about 3,000 Pa·s to about 10,000 Pa·s, about 5,000 Pa·s to about 8,000 Pa·s, or less than, equal to, or greater than about 3,000 Pa·s, 3,500; 4,000; 4,500; 5,000; 5,500; 6,000; 6,500; 7,000; 7,500; 8,000; 8,500; 9,000; 9,500; or about 10,000 Pa·s. The viscosity can be measured using a HAAKE RheoWin machine although other machines are equally well suited for measuring viscosity.

Shim pattern 100, or any other shim pattern described herein can have any suitable dimensions. For example, a thickness, largest width, and a smallest width of shim pattern can be independently chosen from about 1.2 cm to about 40 cm, about 5 cm to about 20 cm, about 10 cm to about 15 cm, or less than, equal to, or greater than about 1.2 cm, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, and about 40 cm.

Curable composition 110 can include additional components and additives. In some embodiments, the additives may be used to toughen cured composition 110 in the event that the shim pattern is left in place in a gap to be used as a shim in an aerospace vehicle. If any of the additives are not transparent to actinic radiation, the amount of the additive in curable composition 110 may have to be low to prevent blockage of the actinic radiation. Examples of suitable additives may include fibrous or particulate fillers. The filler can be glass fibers, aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, zinc oxide, or the like; calcium sulfate (as its anhydride, dehydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin; single crystal fibers or “whiskers” such as silicon carbide, alumina, boron carbide, iron, nickel, copper, or the like; fibers (including continuous and chopped fibers) such as asbestos, carbon fibers; sulfides such as molybdenum sulfide, zinc sulfide, or the like; barium compounds such as barium titanate, barium ferrite, barium sulfate, heavy spar, or the like; metals (e.g., metal mesh, metal plate) and metal oxides such as particulate or fibrous aluminum, bronze, zinc, copper and nickel, or the like; flaked fillers such as glass flakes, flaked silicon carbide, aluminum diboride, aluminum flakes, steel flakes or the like; fibrous fillers, for example short inorganic fibers such as those derived from blends including at least one of aluminum silicates, aluminum oxides, magnesium oxides, and calcium sulfate hemihydrate or the like; natural fillers and reinforcements, such as wood flour obtained by pulverizing wood, fibrous products such as kenaf, cellulose, cotton, sisal, jute, flax, starch, corn flour, lignin, ramie, rattan, agave, bamboo, hemp, ground nut shells, corn, coconut (coir), rice grain husks or the like; organic fillers such as polytetrafluoroethylene, reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as fillers such as mica, clay, feldspar, flue dust, fillite, quartz, quartzite, perlite, Tripoli, diatomaceous earth, carbon black, or the like, or combinations including at least one of the foregoing fillers. The filler can surface treated with silanes, siloxanes, or a combination of silanes and siloxanes to improved adhesion and dispersion. The filler can be a silica filler. The silica filler can be any suitable silica filler, such that the sealant composition can be used as described herein. The silica filler can be fumed silica.

As described herein curable composition 110 can include glass microspheres an example of a glass microsphere are 3M Glass Microspheres from 3M Company or ECCOSPHERES brand hollow glass microspheres from Trelleborg AB, Trelleborg, Sweden. Such fillers can significantly reduce the density of a composition while preserving acceptable mechanical properties after curing. Advantageously, the inclusion of hollow filler particles can significantly reduce the density of the composition and hence the overall weight of the composition in practice. The density of the filler particles can be less than, equal to, or greater than 0.18 g/cm³, 0.3, 0.5, 0.6, 0.8, 1.0, 1.2, 1.4, 1.6, 1.8, or 2 or more.

As a further option, the first and/or second component may further include one or more solid (non-hollow) inorganic fillers. The type of inorganic filler is not especially restricted and could include, for example, fumed silica or calcium carbonate. Useful fillers also include chopped fibers, such as chopped carbon or graphite fibers, glass fibers, boron fibers, silicon carbide fibers, and combinations thereof.

Suitable filers may further include “lightweight fillers.” Suitable lightweight fillers can include hollow microspheres, amorphous materials or aerogels. The specific gravity of the microspheres ranges from about 0.1 to about 0.7 and are exemplified by polystyrene foam, microspheres of polyacrylates and polyolefins, and silica microspheres having particle sizes ranging from 5 to 100 microns and a specific gravity of 0.25. Other examples include alumina/silica microspheres having particle sizes in the range of 5 to 300 microns and a specific gravity of 0.7 sold under the trademark FILLITE by Pluess-Stauffer International, aluminum silicate microspheres having a specific gravity of from about 0.45 to about 0.7 sold under the trademark Z-LIGHT, and calcium carbonate-coated polyvinylidene copolymer microspheres having a specific gravity of 0.13 which are sold under the trademark DUALITE 6001AE by Pierce & Stevens Corp.

The amorphous lightweight fillers typically have a specific gravity ranging from about 1.0 to about 2.2, while an aerogel has a specific gravity of from 0.05 to 0.07. The amorphous lightweight fillers are exemplified by calcium silicates, fumed silica, precipitated silica, and polyethylene. Examples include calcium silicate having a specific gravity of from 2.1 to 2.2 and a particle size of from 3 to 4 microns sold under the trademark HUBERSORB HS-600 by J.M. Huber Corp., and fumed silica having a specific gravity of 1.7 to 1.8 with a particle size less than 1 micron sold under the trademark CAB-O-SIL TS-720 by Cabot Corp. Other examples include precipitated silica having a specific gravity of from 2 to 2.1 sold under the trademark HI-SIL T-7000 by PPG Industries, and polyethylene having a specific gravity of from 1 to 1.1 and a particle size of from 10 to 20 microns sold under the trademark SHAMROCK S-395 by Shamrock Technologies Inc. The amounts of the microspheric and amorphous lightweight fillers used in the lightweight sealant may be from about 0.3 to about 10% and from about 4% to about 15% of the total weight of the sealant, respectively.

FIG. 2 is a schematic diagram of shim pattern 100A. Shim pattern 100A shares many of the same components as shim pattern 100, but additionally includes first adhesive layer 112 and second adhesive layer 114. First adhesive layer 112 coats first release film 102 and second adhesive layer 114 coats second release film 104. Although both first adhesive layer 112 and second adhesive layer 114 are shown, shim pattern 100A can include either adhesive layer exclusively without the other adhesive layer.

Either of first adhesive layer 112 or second adhesive layer 114 can include an adhesive chosen from a pressure-sensitive adhesive, a non-pressure sensitive adhesive, a light-triggered adhesive, and mixtures thereof. The adhesive can be any one of a number of pressure sensitive adhesives or non-pressure sensitive adhesives. Examples of suitable pressure sensitive adhesives include a natural rubber-based adhesive, a synthetic rubber based adhesive, a styrene block copolymer-based adhesive, a polyvinyl ether-based adhesive, a poly(methyl acrylate)-based adhesive, a polyolefin-based adhesive, or a silicone-based adhesive. As used herein, an adhesive that is “based” on a particular component means that the adhesive includes at least 50 wt. % of the particular component, based on the total weight of the adhesive. An exemplary adhesive is available under the designated trade designation “KRATON MD6748” from Kraton, Houston, Tex.

Suitable non-pressure sensitive adhesives include those that “self-bond” or “block” at the temperature the polymeric multilayer material is extruded at. Examples of suitable non-pressure sensitive adhesives include very low-density polyethylene resins or ethylene copolymer resins with high comonomer content such as a high vinyl acetate containing ethylene vinyl acetate resin. Either of first adhesive layer 112, second adhesive layer 114, or both can be at least partially transparent to actinic radiation.

Including either first adhesive layer 112, second adhesive layer 114, or both can be helpful in situations where shim pattern 100 cannot be set and left on a surface without falling or shifting. Including first adhesive layer 112, second adhesive layer 114, or both can allow a user to fixedly position shim pattern 100A on an aircraft component. The specific adhesive component can be selected to be one that can facilitate easy removal and leave little to no residue on the aircraft component.

Each of shim pattern 100 and 100A are open constructions in that curable precursor 110 is not in sealed or at least substantially sealed environment. FIG. 3, is a schematic depiction of shim pattern 100B. Shim pattern 100B includes many of the same components shim patterns 100 and 100A. However, shim pattern 100B does not include second release film 104. Shim pattern 100B does include perforations 116. Shim pattern 100B can also include first adhesive layer 112 if desired.

Shim pattern 100B, forms a bag or pouch that at least partially encloses curable composition 110. First end 106 and second end 108 of shim pattern 100B are joined to each other to create the bag. First end 106 and second end 108 can be joined by an adhesive or through heat bonding A volume of space 118 defined by the interior of shim pattern 100B is greater than a volume of curable composition 110. This can allow curable composition 110 to have enough space to expand and conform to the shape of the gap or seam into which shim pattern 100B is placed. To prevent excess pressure build-up, perforations 116 will allow air or excess curable composition 110 to exit. Perforations 116 can be located on first release film 102 such that air is more likely to exit through perforations 116 than excess curable composition 110. This can help to reduce the potential mess of excess curable composition 110 exiting shim pattern 100B.

Any of shim patterns 100, 100A, or 100B can be manufactured according to the general method described herein. The method can include contacting curable composition 110 with first release film 102 and, if present, second release film 104. The components of curable composition 110 can be premixed ahead of contact with either first release film 102 or second release film 104. Alternatively, the components of curable composition 110 can be mixed in situ immediately following contact with either film. Because it is possible for curable composition to begin curing immediately, even in the absence of light, it can be desirable to freeze curable composition 110 to a solid state in order to bring the rate of the curing reaction to a very low value. This can allow for the use of shim pattern 100, 100A, and 100B to be at a user's discretion.

If shim pattern 100B is being assembled, then the method will further include contacting and joining first end 106 and second end 108 to each other using the techniques described herein. In shim pattern 100B, first release film 102 can take on a shape similar to a bag with an open end that the mixed curable composition 110 is extruded into. The opening can be closed when a sufficient amount of curable composition 110 is extruded into space 118. If not already present, perforations 116 can then be formed in first release film 102. Shim pattern 100B can then be frozen. Shim pattern 100B can be presized to generally conform to the gap into which it will ultimately be placed.

Further steps in assembling any of shim patterns 100, 100A, or 100B, can include applying an adhesive to form adhesive layers 112 or 114 on first release film 102 and 104. Release liners may be applied to the exposed adhesive.

Following assembly, shim patterns 100, 100A, or 100B can be rolled or stored as a flat assembly. Upon use, the user can use any of shim patterns 100, 100A, or 100B in its entirety, or cut a subsection of the entire precursor for use. Different sections of shim patterns 100, 100A, or 100B, can be labeled so that they can be cut away and applied to different areas of an airplane. The location of specific precursors can be recorded so that the shims formed from the precursors can used at the location that the respective shim pattern was formed.

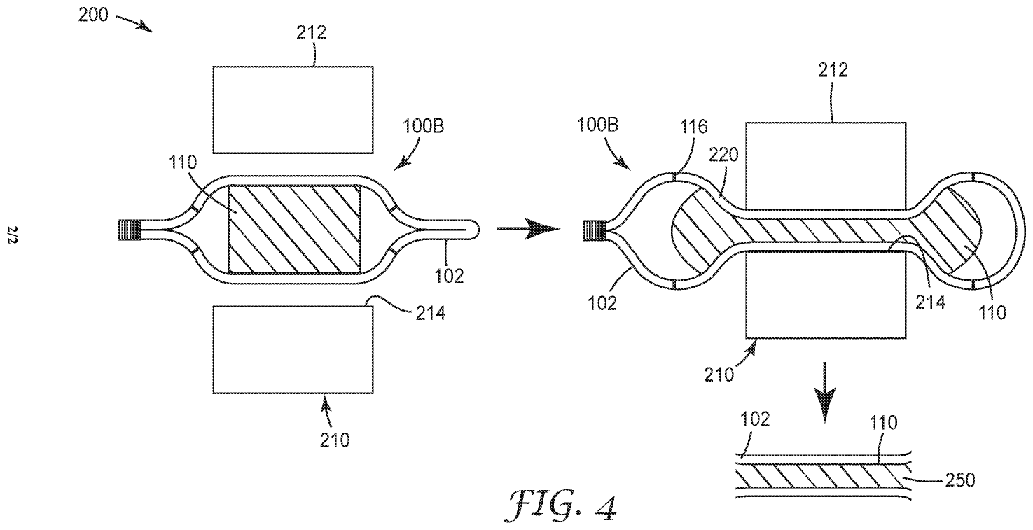

Method 200 of using any one of shim patterns 100, 100A, or 100B is schematically illustrated in FIG. 4. In FIG. 4 shim pattern 100B is illustrated although any other shim pattern can be used. As illustrated in FIG. 4, shim pattern 100B is positioned between first substrate 210 and second substrate 212. First substrate 210 includes irregular surface 214. Irregular surface 214 can be formed through manufacturing imperfections.

First substrate 210 and second substrate 212 are aircraft components. Examples of suitable aircraft components include an aircraft skin, an aircraft fastener, an aircraft window, an aircraft access panel, a fuselage protrusion, an aircraft fuel tank, an aircraft spar, an aircraft stringer. As can be seen from FIG. 4, irregular surface 214 would make it impossible for first substrate 210 and second substrate 212 to be joined without a gap formed therebetween. The presence of the gap can affect the structural integrity of the aircraft or lead to dents in the aircraft body that can affect the aerodynamic performance of the aircraft or make the aircraft look esthetically unappealing.

To close the gap, shim pattern 100B is placed between first substrate 210 and second substrate 212. First substrate 210 and second substrate 212 are brought into contact with shim pattern 100B and sufficient force is applied to compress curable composition 110. This forms an assembly including shim pattern 100B, first substrate 210 and second substrate 212.

Within the assembly, curable composition 110 is at least partially cured. If, for example, curable composition 110 is capable of being cured with exposure to actinic radiation, then curing will be accomplished by exposing it to actinic radiation such as blue light for a suitable amount of time. It is possible that curable composition 110 is not entirely cured by this operation. This may be because certain regions of curable composition 110 are shielded by either first substrate 112 or second substrate 114, such that they cannot be exposed to the blue light. Additionally, although it is possible to achieve a depth of cure of about 100% thickness of curable composition 110, the depth of cure may in a range of from about 40% to about 100%, about 50% to about 100%, about 60% to about 100%, about 70% to about 100%, about 80% to about 100%, about 90% to about 100%, or less than, equal to, or greater than about 40%, 45, 50, 55, 60, 65, 70, 75, 80, 85, 90, 95, or about 100%.

However, even if curable composition 110 is not completely cured, it is possible to cure enough of curable composition that the shape of the at least partially cured composition can be retained upon removal from the assembly. If curable composition 110 has a low viscosity this can help to retain the structure of the at least partially cured composition. As can be seen the structure of the at least partially cured composition is different than that of curable composition 110 prior to compression. The shape of the partially cured composition is generally a negative impression of a gap or seam between first substrate 210 and second substrate 220.

To remove the at least partially cured composition, first substrate 210 and second substrate 212 are disengaged from shim pattern 100B. First release film 102 helps to prevent substantial adhesion between shim pattern 100B and either of first substrate 210 and second substrate 212. Following disengagement, the at least partially cured composition can be exposed to further blue light, to fully cure the composition. Alternatively, if the at least partially cured composition is able to substantially retain its structure, the at least partially cured composition can be left out in ambient conditions to complete the curing process.

Following curing, excess curable composition 220 is trimmed from cured shim pattern 250. Excess curable composition 220 is that which is dislodged from the space between first substrate 210 and second substrate 212. It is possible for some excess curable composition 220 to exit through perforations 116.

To make the actual shim that will be included in the aircraft, cured shim pattern 250 is used to render a digital copy of cured shim pattern 250. The digital copy can be rendered using any suitable method. For example, the dimensions of cured shim pattern can be measured with a using a profilometer or an isoscope. Additionally, cured shim pattern 250 can be scanned to determine its dimensions. Suitable scanning techniques include 3D laser scanning. Using a computer component, such as a controller, the digital copy cured shim pattern 250 can be converted into a model in any suitable output regardless of geometric complexity such as a Computer Aided Design (CAD) model. r. The digital model can account for the presence of a release film by subtracting those dimensions from the rendering or those dimensions can be included in the digital rendering.

The controller of the same system or another system can issue a command to a manufacturing device to produce the final shim. The manufacturing device can be a machining device or an additive manufacturing device. Examples of suitable additive manufacturing techniques include extrusion freeform fabrication (EFF), Stereolithography (SLA), binder/ink jetting, and Selective Laser Sintering (SLS).

Alternatively, any of shim patterns 100, 100A, or 100B can be cured in the gap and left in place. Thus, the cured shim pattern can become the final shim.

The material of the final shim can be chosen from any suitable material. Factors to consider in choosing the appropriate material include the strength, resiliency, and weight of the material.

### Additional Embodiments.

The following exemplary embodiments are provided, the numbering of which is not to be construed as designating levels of importance:

Embodiment 1 provides a shim pattern comprising:
a release film; and
a curable composition disposed on the release film.

Embodiment 2 provides the shim pattern of Embodiment 1, wherein the release film is a first release film and the shim pattern optionally further comprises a second release film, having the curable composition disposed thereon.

Embodiment 3 provides the shim pattern of Embodiment 2, wherein the curable composition is located between the first release film and the second release film.

Embodiment 4 provides the shim pattern of any one of Embodiments 2 or 3, wherein the release film comprises a polyolefin, a silicon, a polyester, or mixtures thereof.

Embodiment 5 provides the shim pattern of any one of Embodiments 1-4, wherein the release film is at least partially transparent to actinic radiation.

Embodiment 6 provides the shim pattern of any one of Embodiments 1-5, wherein the curable composition comprises a composition that is thermally-curable, radiation-curable, chemically-curable, or a combination thereof.

Embodiment 7 provides the shim pattern of any one of Embodiments 1-6, wherein the curable composition is radiation-curable.

Embodiment 8 provides the shim pattern of Embodiment 7, wherein the curable composition is at least partially cured upon exposure to actinic radiation.

Embodiment 9 provides the shim pattern of Embodiment 7, wherein the curable composition is at least partially cured upon exposure to blue light.

Embodiment 10 provides the shim pattern of Embodiment 9, wherein the blue light has a frequency in a range of from about 300 nm to about 500 nm.

Embodiment 11 provides the shim pattern of any one of Embodiments 9-10, wherein the blue light has a frequency in a range of from about 450 nm to about 495 nm.

Embodiment 12 provides the shim pattern of any one of Embodiments 1-11, wherein the curable composition comprises:
a polythiol;
an unsaturated compound having at least two non-aromatic carbon-carbon double bonds, at least one carbon-carbon triple bond, or a combination thereof.

Embodiment 13 provides the shim pattern of Embodiment 12, wherein the curable composition further comprises:
an organoborane-amine complex;
an organic peroxide; and
a photoinitiator system.

Embodiment 14 provides the shim pattern of any one of Embodiments 12 or 13, wherein the polythiol comprises an aliphatic polythiol.

Embodiment 15 provides the shim pattern of any one of Embodiments 12-14, wherein the unsaturated compound comprises a compound having at least two vinyl groups.

Embodiment 16 provides the shim pattern of any one of Embodiments 12-15, wherein the photoinitiator system comprises an acylphosphine-oxide.

Embodiment 17 provides the shim pattern of any one of Embodiments 12-16, wherein the curable composition is a premixed two-part curable composition.

Embodiment 18 provides the shim pattern of Embodiment 17, wherein a first part of the two-part curable composition comprises the polythiol and a second part of the two-part curable composition comprises the unsaturated compound.

Embodiment 19 provides the shim pattern of Embodiment 17, wherein the curable composition is frozen.

Embodiment 20 provides the shim pattern of any one of Embodiments 9-19, wherein an intensity of the blue light is in a range of from about 400 mW/cm² to about 1000 mW/cm².

Embodiment 21 provides the shim pattern of any one of Embodiments 9-20, wherein an intensity of the blue light is in a range of from about 600 mW/cm² to about 900 mW/cm².

Embodiment 22 provides the shim pattern of any one of Embodiments 1-21, wherein a viscosity of the curable composition at a temperature of about 3,000 Pa·s to about 10,000 Pa·s.

Embodiment 23 provides the shim pattern of any one of Embodiments 2-22, further comprising an adhesive layer at least partially coating the release film on a surface opposite the curable composition.

Embodiment 24 provides the shim pattern of Embodiment 23, wherein the adhesive layer comprises an adhesive chosen from a pressure-sensitive adhesive, a non-pressure sensitive adhesive, a light-triggered adhesive, and mixtures thereof.

Embodiment 25 provides the shim pattern of Embodiment 24, wherein the pressure-sensitive adhesive is chosen from a natural rubber-based adhesive, a synthetic rubber based adhesive, a styrene block copolymer-based adhesive, a polyvinyl ether-based adhesive, a poly(methyl acrylate)-based adhesive, a polyolefin-based adhesive, or a silicone-based adhesive, and mixtures thereof.

Embodiment 26 provides the shim pattern of Embodiment 24, wherein the light triggered-adhesive comprises a curable adhesive composition that is configured to be cured upon exposure to ultra-violet radiation.

Embodiment 27 provides the shim pattern of any one of Embodiments 23-26, wherein the adhesive is at least partially transparent to actinic radiation.

Embodiment 28 provides the shim pattern of any one of Embodiments 1-27, further comprising a plurality of microspheres, a plurality of hollow filaments, a woven hollow filament fiber fabric, or combinations thereof located within the curable composition.

Embodiment 29 provides the shim pattern of Embodiment 28, wherein at least one of the microspheres comprises a catalyst for curing the curable composition.

Embodiment 30 provides the shim pattern of any one of Embodiments 28 or 29, wherein at least one of the microspheres a woven hollow filament fiber fabric, or combinations thereof is transparent to actinic light.

Embodiment 31 provides the shim pattern of any one of Embodiments 1-30, wherein the release film comprises a first end and an opposite second end that are joined at an interface therebetween to at least partially envelop the curable composition.

Embodiment 32 provides the shim pattern of Embodiment 31, wherein a volume of space defined internally by the release film is greater than a volume of the curable composition.

Embodiment 33 provides the shim pattern of any one of Embodiments 31 or 32, wherein the release film comprises a perforation extending through the release film.

Embodiment 34 provides the shim pattern of claim 33, wherein the release film comprises a plurality of perforations spaced across the release film.

Embodiment 35 provides the shim pattern of any one of Embodiments 23-34, wherein a thickness of at least one of the release film and the adhesive layer is independently less than a thickness of the curable composition.

Embodiment 36 provides an assembly comprising:
a first substrate;
a second substrate; and
the shim pattern of any one of Embodiments 1-35, wherein the shim pattern is in contact with the first substrate and the second substrate.

Embodiment 37 provides the assembly of Embodiment 36, wherein the first substrate and the second substrate independently comprise an aircraft component.

Embodiment 38 provides the assembly of any one of Embodiments 36 or 37, wherein the aircraft component is independently chosen from an aircraft skin, an aircraft fastener, an aircraft window, an aircraft access panel, a fuselage protrusion, an aircraft fuel tank, an aircraft spar, an aircraft stringer, and a combination thereof.

Embodiment 39 provides the assembly of any one of Embodiments 36-38, wherein the shim pattern is located in a gap or a seam between the first substrate and the second substrate.

Embodiment 40 provides the assembly of any one of Embodiments 36-39, wherein the shim pattern is adhered to at least one of the first substrate and the second substrate.

Embodiment 41 provides a method of making the shim pattern of any one Embodiments 2-40, the method comprising contacting the curable composition with at least one of the first release film and the second release film.

Embodiment 42 provides the method of Embodiment 41, further comprising contacting at least one of the first release film and the second release film with an adhesive layer.

Embodiment 43 provides the method of any one of Embodiments 41 or 42, further comprising mixing components of the curable composition before contacting the curable composition with at least one of the first release film and the second release film.

Embodiment 44 provides the method of any one of Embodiments 41-43, further comprising freezing the curable composition.

Embodiment 45 provides the method of any one of Embodiments 41-44, further comprising bringing a first end of the first release film into contact with a second end of the first release film to at least partially envelop the curable composition.

Embodiment 46 provides the method of Embodiment 45, further comprising joining the first end of the first release film and the second end of the first release film through heat bonding, an adhesive, or a combination thereof.

Embodiment 47 provides a method of using the shim pattern of any one of Embodiments 36-46, the method comprising:
contacting the shim pattern with at least one of the first substrate and the second substrate;
moving at least one of the first substrate and the second substrate relative to each other to compress the curable composition;
at least partially curing the curable composition; and
removing the at least partially cured composition from contact with at least one of the first substrate and the second substrate.

Embodiment 48 provides the method of Embodiment 47, wherein a first shape of the curable composition when the shim pattern is contacted with at least one the first substrate and the second substrate is different from a shape of the at least partially cured composition.

Embodiment 49 provides the method of any one of Embodiments 47 or 48, wherein a shape of the at least partially cured composition is generally a negative impression of a gap or seam between the first substrate and the second substrate.

Embodiment 50 provides the method of any one of Embodiments 47-49, further comprising fully curing the at least partially cured composition to form a cured shim pattern.

Embodiment 51 provides the method of any one of Embodiments 47-50, wherein curing the curable composition comprises contacting at least a portion of the curable composition with actinic radiation.

Embodiment 52 provides the method of any one of Embodiments 47-51, wherein curing the curable composition comprises contacting at least a portion of the curable composition with blue electromagnetic radiation.

Embodiment 53 provides the method of any one of Embodiments 51 or 52, wherein curing further comprises allowing the curable composition to self-cure at ambient temperatures following contact with the actinic radiation.

Embodiment 54 provides the method of any one of Embodiments 47-53, wherein a depth of cure of the at least partially cured curable composition is in a range of from about 40% to about 100% of the thickness of the curable composition.

Embodiment 55 provides the method of any one of Embodiments 47-54, wherein a depth of cure of the at least partially cured curable composition is in a range of from about 80% to about 100% of the thickness of the curable composition.

Embodiment 56 provides the method of any one of Embodiments 47-55, wherein contacting the shim pattern with at least one of the first substrate and the second substrate comprises adhering the shim pattern thereto.

Embodiment 57 provides a method of making a shim, the method comprising:
providing or receiving the at least partially cured composition formed according to any one of Embodiments 50-56;
rendering a digital copy of the cured shim pattern; and
producing a shim based on the digital copy of the cured shim pattern.

Embodiment 58 provides the method of Embodiment 57, wherein digitally rendering the copy of the cured shim pattern comprises:
measuring the dimensions of the cured shim pattern; and
creating a digital copy of the cured shim pattern.

Embodiment 59 provides the method of any one of Embodiments 57 or 58, wherein producing the shim comprises:
using a controller to process the digital copy of the cured shim pattern in a control; and
using the controller to issue a command to a device to produce the shim.

Embodiment 60 provides the method of Embodiment 59, wherein the device is an additive manufacturing device or a machining device.

Embodiment 61 provides an aircraft comprising the shim formed according to the method of any one of Embodiments 57-60.

1. A shim pattern comprising:
a release film; and
a curable composition disposed on the release film.

2-6. (canceled)

7. The shim pattern of claim 1, wherein the curable composition is radiation-curable.

8-11. (canceled)

12. The shim pattern of claim 1, wherein the curable composition comprises:
a polythiol;
an unsaturated compound having at least two non-aromatic carbon-carbon double bonds, at least one carbon-carbon triple bond, or a combination thereof.

13. The shim pattern of claim 12, wherein the curable composition further comprises:
an organoborane-amine complex;
an organic peroxide; and
a photoinitiator system.

14. The shim pattern of claim 12, wherein the polythiol comprises an aliphatic polythiol.

15. The shim pattern of claim 12, wherein the unsaturated compound comprises a compound having at least two vinyl groups.

16. The shim pattern of claim 12, wherein the photoinitiator system comprises an acylphosphine-oxide.

17. The shim pattern of claim 12, wherein the curable composition is a premixed two-part curable composition.

18. The shim pattern of claim 17, wherein a first part of the two-part curable composition comprises the polythiol and a second part of the two-part curable composition comprises the unsaturated compound.

19-22. (canceled)

23. The shim pattern of claim 1, further comprising an adhesive layer at least partially coating the release film on a surface opposite the curable composition.

24. The shim pattern of claim 23, wherein the adhesive layer comprises an adhesive chosen from a pressure-sensitive adhesive, a non-pressure sensitive adhesive, a light-triggered adhesive, and mixtures thereof.

25-30. (canceled)

31. The shim pattern of claim 1, wherein the release film comprises a first end and an opposite second end that are joined at an interface therebetween to at least partially envelop the curable composition.

32. The shim pattern of claim 31, wherein a volume of space defined internally by the release film is greater than a volume of the curable composition.

33. The shim pattern of claim 31, wherein the release film comprises a perforation extending through the release film.

34. The shim pattern of claim 33, wherein the release film comprises a plurality of perforations spaced across the release film.

35. (canceled)

36. An assembly comprising:
a first substrate;
a second substrate; and
the shim pattern of claim 1, wherein the shim pattern is in contact with the first substrate and the second substrate.

37-46. (canceled)

47. A method of using the shim pattern of claim 36, the method comprising:
contacting the shim pattern with at least one of the first substrate and the second substrate;
moving at least one of the first substrate and the second substrate relative to each other to compress the curable composition;
at least partially curing the curable composition; and
removing the at least partially cured composition from contact with at least one of the first substrate and the second substrate.

48-56. (canceled)

57. A method of making a shim, the method comprising:
providing or receiving the at least partially cured composition formed according to claim 47;
fully curing the at least partially cured composition to form a cured shim pattern;
rendering a digital copy of the cured shim pattern; and
producing a shim based on the digital copy of the cured shim pattern.

58. The method of claim 57, wherein digitally rendering the copy of the cured shim pattern comprises:
measuring the dimensions of the cured shim pattern; and
creating a digital copy of the cured shim pattern.

59. The method of claim 57, wherein producing the shim comprises:
using a controller to process the digital copy of the cured shim pattern in a control; and
using the controller to issue a command to a device to produce the shim.

60-61. (canceled)
